(19) United States
(12) Patent Application Publication
(10) Pub. No.: US 2001/0056370 A1
(43) Pub. Date: Dec. 27, 2001

(54) Method and system for presenting an animated advertisement on a web page

(76) Inventor: Sivan Tafla, Petach-Tikva (IL)

Correspondence Address: FISH & RICHARDSON, PC, 4350 LA JOLLA VILLAGE DRIVE, SUITE 500, SAN DIEGO, CA, 92122, US

(21) Appl. No.: 09/825,439

(22) Filed: Apr. 2, 2001

Related U.S. Application Data
(63) Continuation-in-part of application No. 09/502,182, filed on Feb. 10, 2000.

(51) Int. Cl. G06F 17/60

(52) U.S. Cl. 705/14

(57) ABSTRACT

A method for presenting an animated advertisement on a web page, in which a web server obtains a web page layer adapted to contain an animated advertisement content having at least one object adapted to run across a web page downloaded to a client computer connected to the web server without obscuring or disabling portions of the web page lying outside a boundary of the objects at any given instant of time. The web server then downloads the web page layer to the client computer for displaying the animated advertisement content in association with the web page. Preferably, the animated advertisement is displayed as a brief animated clip relating to a product or service to grab an observer's attention, and displaying a link to an advertisement stored in association with an advertisement web server associated with the product or service. This allows the observer to get further information relating to the product or service by clicking on the link. The animated advertisement thus serves as a teaser for enticing a user at the client machine to request an advertisement and the link serves as a reminder of the advertisement after termination of the teaser. Preferably, an agent is provided in the client machine for maintaining the advertisement in view regardless of any scrolling of the web page.

### RELATED APPLICATION

This invention is a continuation in part of U.S. Ser. No. 09/502,182 filed on Feb. 10, 2000 and entitled “Method for dynamically superimposing multimedia on a background object downloaded through the Internet”.

### FIELD OF THE INVENTION

This invention relates to advertising over the Internet.

### BACKGROUND OF THE INVENTION

Many Internet sites make provision for the inclusion of advertisement banners in their web pages. In such case, a predetermined area of the web page is designated for the inclusion of an advertising banner that is downloaded from a specified web server whose address is also specified when the web page is designed. If the advertising banner itself changes, then the change will automatically be reflected in the web page reaching a client without requiring any change to the web page downloaded by the client. Moreover, the need to allocate an area of the web page to the advertisement banner limits the area of the web page that is available for conveying other information specific to the web site. Thus, the web site must sacrifice some of its own valuable area in order to support the advertising banner.

Advertising banners are designed to appeal to the web surfer in the hope that the advertised product or service will be of sufficient interest to the web surfer that he will be inclined to click on the advertisement banner and, by so doing, enter the referent web site. In fact, user reaction to static or multimedia based banners is very low and simply not comparable to other advertising and direct mail response rates.

Classical banners can convey only a simple static message. As noted above, usually all presentations are predefined and pre-created. To this extent, they are no different than an advertisement stuck to a car or bus. They are further usually limited to a limited amount of information. For example, some portals limit the banner weight to 9-12 k bytes.

Animation programs are known which allow animated objects to be created within a predefined window. Such objects may, if desired, have the property that any area within the boundary of the window not actually overlayed by the object is transparent. So far as is known, it has not been suggested to embed animation objects in lieu of a conventional advertising banner in order to present an animated advertisement to the web surfer. However, even if such were done, this would still have to be accommodated in the web page and so would not address the loss of useful area available to the web site for conveying its own proprietary information.

It would therefore be desirable to allow an animated advertisement to be associated with a web page for conveying through the web without requiring that space be reserved in the web page for accommodating the animated advertisement. Furthermore, the dynamic nature of an animated advertisement would be improved and better adapted to capture a user's attention if its location relative to the host web page were also dynamic. This would be even further enhanced if the timing of the dynamic banner were itself unpredictable to the end-user. It would also be desirable to allow the advertisement to be shown without requiring special action on the part of the web surfer.

Other drawbacks associated with known advertising techniques, particularly those employed in the Internet environment, relate to the fact clicking on an advertising banner frequently re-directs the user away from the originally displayed web page and irreversibly accesses the selected advertisement web page. This is often a cause of frustration to the user and indeed is well known to discourage many Internet users from clicking on a displayed advertisement link in the first place.

A further issue relates to the manner in which web ad agencies charge for their service. It will be understood that web ad agencies are service providers who serve the advertising community in much the same way that any other web server provides a service. To this end, web ad agencies act as a repository for their clients, frequently storing a plurality of advertisements in respect of a client and sending to a potential interested web surfer that advertisement deemed by the ad agency to be of most likely appeal based, for example, on a stored profile of user preferences. These techniques are well known per se. A typical approach is for web ad agencies to charge their clients an agreed sum for each 1,000 advertisements sent on the client's behalf to potentially interested parties.

It is believed by the present Applicant that advertising revenue would be increased to the benefit of the ad agencies if their services were charged for on the basis of the elapsed time during which an advertisement is displayed at the client machine, in much the same manner that television advertisements are charged for. However, so far as is known, no mechanism has been proposed for allowing display time of an advertisement downloaded by a client machine from an ad agency server to be monitored by the ad agency.

### SUMMARY OF THE INVENTION

It is therefore an object of the invention to provide an animated advertisement for use with a web page, which does not require that space be reserved in the web page for accommodating the animated advertisement.

According to a first aspect of the invention there is provided a method for presenting an animated advertisement on a web page, comprising the following steps all carried out by a web server:

(a) obtaining a web page layer adapted to contain an animated advertisement content having at least one object adapted to run across a web page downloaded to a client computer connected to the web server without obscuring or disabling portions of the web page lying outside a boundary of said objects at any given instant of time, and

(b) downloading said web page layer to the client computer for displaying the animated advertisement content in association with the web page.

According to a specific embodiment, the web page and the web page layer are downloaded to the client computer by the same web server. More generally, however, the web page and the web page layer may be downloaded to the client computer by different web servers.

According to a second aspect of the invention, there is provided a method for presenting an animated advertisement on a web page, comprising the following steps all carried out by a client computer connected to a web server:

(a) downloading a web page from the web server,

(b) superimposing over said web page a web page layer containing the animated advertisement having at least one object adapted to run across the web page without obscuring or disabling portions of the web page lying outside a boundary of said objects at any given instant of time, and

(c) applying a trigger signal for starting the animated advertisement.

Preferably, the web page layer is a DHTML layer containing an animated object adapted to be viewed in association with the web page. As the object moves relative to the web page, only those portions of the web page overlaid at any instant of time by the object are obscured.

According to a third aspect of the invention, there is provided a method for presenting an advertisement on a web page, comprising the following steps all carried out by a client computer connected to a web server:

(a) displaying a brief animated clip relating to a product or service to grab an observer's attention, and

(b) displaying a link to an advertising page stored in association with an advertisement web server associated with said product or service so as to allow the observer to download further information relating to the product or service.

Such a method allows a so-called “teaser” to be downloaded by the client, preferably in the form of an animated advertisement as described above. The animation typically lasts only a few seconds so as to grab the user's attention and then disappears so as not to distract the user. Thereafter, a link to the ad server stays on the previously displayed web page, which remains otherwise unchanged. Therefore, during this process, the user remains connected to the web page subject of his or her selection and is not re-directed to a web site of potentially no interest. However, if the user would like to receive further details relating to the product or service subject of the “teaser”, he or she can click on the displayed link, whereupon the web browser in the client machine re-directs the client machine to the requested web site. The displayed link thus serves as a permanent “reminder” of the brief animated advertisement clip previously displayed intermittently.

Preferably, clicking on the “reminder” redisplays the brief animated advertisement clip in the form of a “main movie” including command buttons for allowing the user to interact with the displayed image.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1a is an exploded pictorial representation of a web page and a web page layer bearing an animated advertisement;

FIG. 1b is a pictorial representation of the web page layer shown in FIG. 1a superimposed on the web page therein;

FIG. 2a is an exploded pictorial representation of the web page and a subsequent frame of the web page layer;

FIG. 2b is a pictorial representation of the web page layer shown in FIG. 2a superimposed on the web page therein;

FIG. 3 is a flow diagram showing the principal operating steps associated with a method carried out by a web server in accordance with the invention;

FIG. 4 is a flow diagram showing the principal operating steps associated with a method carried out by a client machine in accordance with a first embodiment of the invention;

FIG. 5 is a flow diagram showing the principal operating steps associated with a method carried out by a client machine in accordance with a second embodiment of the invention;

FIG. 6 is a block diagram showing functionally a system including a web server and a client machine for implementing the invention;

FIG. 7 is a flow diagram showing the principal operating steps associated with a method carried out by a client machine in accordance with a third embodiment of the invention;

FIGS. 8a to 8c are a flow diagram showing the principal operating steps associated with a method carried out by a web server and a client machine in accordance with the third embodiment of the invention;

FIG. 8d is a flow diagram showing the principal operating steps associated with continuous background process carried out by the web server in accordance with the third embodiment of the invention;

FIGS. 9 to 14 show pictorially screen dumps associated with the third embodiment of the invention;

FIG. 15 is a pictorial representation of a floating animation object displayed on a client machine as a web page layer; and

FIG. 16 is a flow diagram showing the principal operating steps carried out by an agent in the client machine for maintaining the floating animation object visible during scrolling of the client machine display.

### DETAILED DESCRIPTION OF THE INVENTION

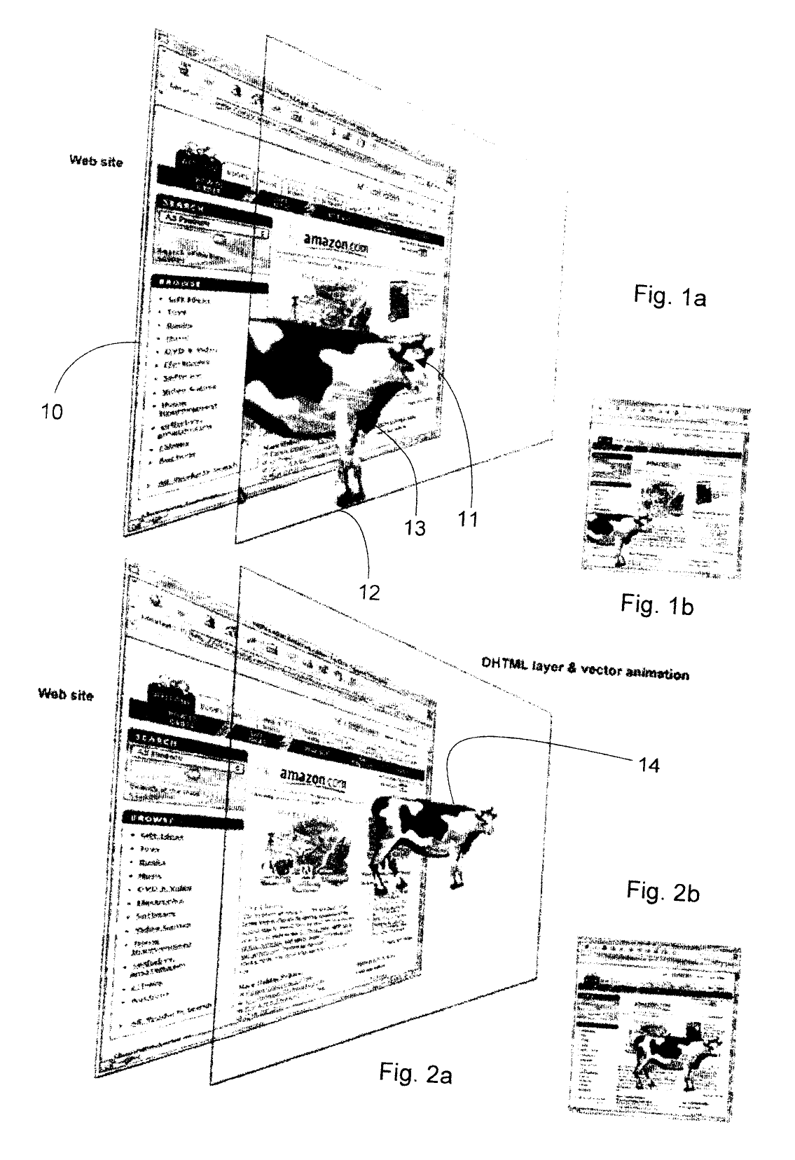

FIGS. 1a and 2a show a web page 10 written using HTML in known manner. Independently, an animated advertisement 11 is embedded within a separate web page layer 12 using known DHTML technology. The animation itself is likewise accomplished using off-the-shelf vector graphic tools and is not per se a feature of the invention. In a preferred embodiment reduced to practice, the animation was prepared using Flash, this being a proprietary vector graphics program produced and distributed by Macromedia Inc. Details and virtual examples can be seen in their website http://www.flash.com/. Flash is a registered trademark of Macromedia Inc.

A cow 13 in the animated advertisement 11 constitutes at least one object that is adapted to run across the web page without obscuring or disabling portions of the web page 10 lying outside a boundary 14 of the cow 13 at any given instant of time. The animated cow 13 may move within an imaginary rectangle within the web page layer 12 of just sufficient dimension to accommodate the cow or the rectangle may be the whole web page layer 12. This is not in itself significant because, as noted above, only the boundary or contour of the object constituting the cow 13 determines what portions, if any, of the underlying web page 10 are obscured and disabled. Specifically, and most importantly, any portions of the web page 10 outside the boundary 14 of the cow 13 at any instant of time are visible to the web surfer and are fully enabled. In fact, those portions of the web page 10 within the boundary 14 of the cow 13 at any instant of time, whilst obscured, are still enabled albeit instantaneously inaccessible to the web surfer. It is often desirable that as the animation runs, critical parts of the web page remain visible even as the animation object or objects move across the web page. To this end, at least part of the animation object or objects may be translucent.

FIGS. 1b and 2b show pictorially the web page layer 12 shown in FIGS. 1a and 2a, respectively, superimposed on the web page 10 therein. The cow 12 moves across the web layer, obscuring different portions of the web page at successive instants of time. However, all other portions of the web page 10 remain visible and enabled.

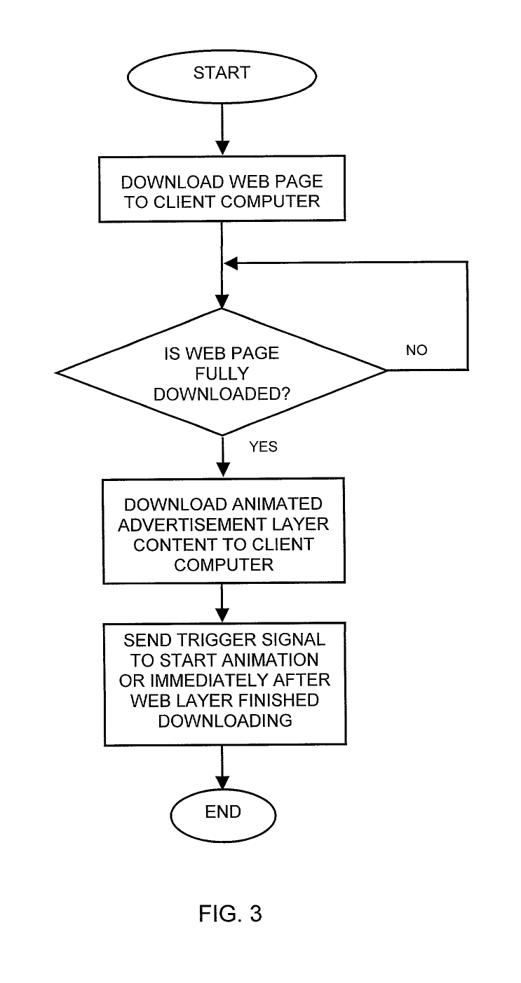

Referring to FIG. 3 there will be described a method for presenting an animated advertisement on a web page, comprising the following steps all carried out by a web server. A web page is initially downloaded to a client computer connected to the web server. Thereafter, preferably after the web page finished downloading to the client computer, the animated advertisement layer content is downloaded to the client computer. As noted above, this may be done by the same web server or by a different web server. The animated advertisement contains at least one object adapted to run across the web page without obscuring or disabling portions of the web page lying outside a boundary of said objects at any given instant of time. Having been thus downloaded, the animated advertisement remains in memory within the client computer and is disabled such that the client user (or web surfer) sees only the web page. In order for the animated advertisement to appear superimposed on the web page, it must first be triggered. This can be done in several ways. Thus, a trigger signal may be sent by the web server to the client for starting the animation a predetermined time interval after downloading to the client computer. Here, too, the trigger signal can be sent by a completely independent web server if required. Alternatively, the animated advertisement may include an integral trigger signal for running the animated advertisement a predetermined time after being downloaded to the client. According to yet another possibility, a mobile program, such as a Java applet, may be downloaded to the client computer for creating the trigger signal. Java is a registered trademark of Sun Microsystems Limited. In any event, the trigger signal may be independent of any activity performed by a user of the client computer. Alternatively, the trigger signal may be generated consequent to predetermined activity by the user, such as dragging the mouse and so on.

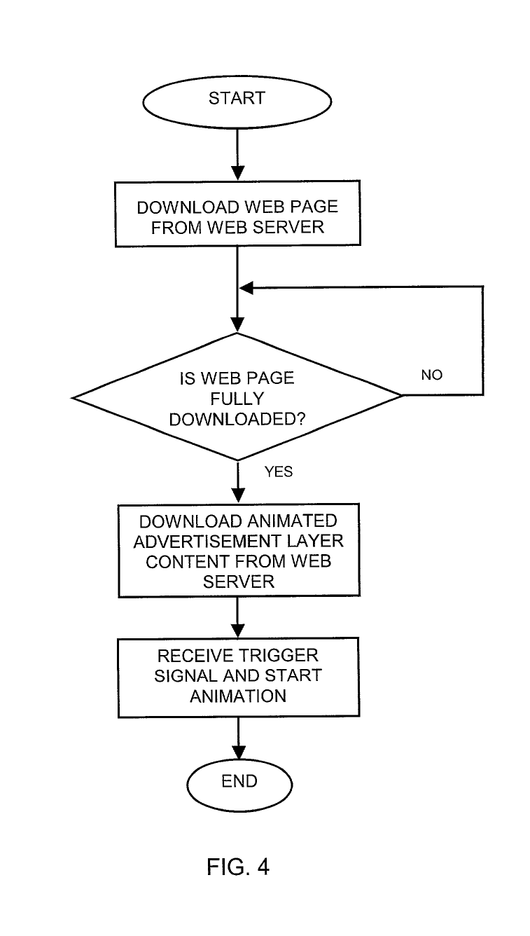

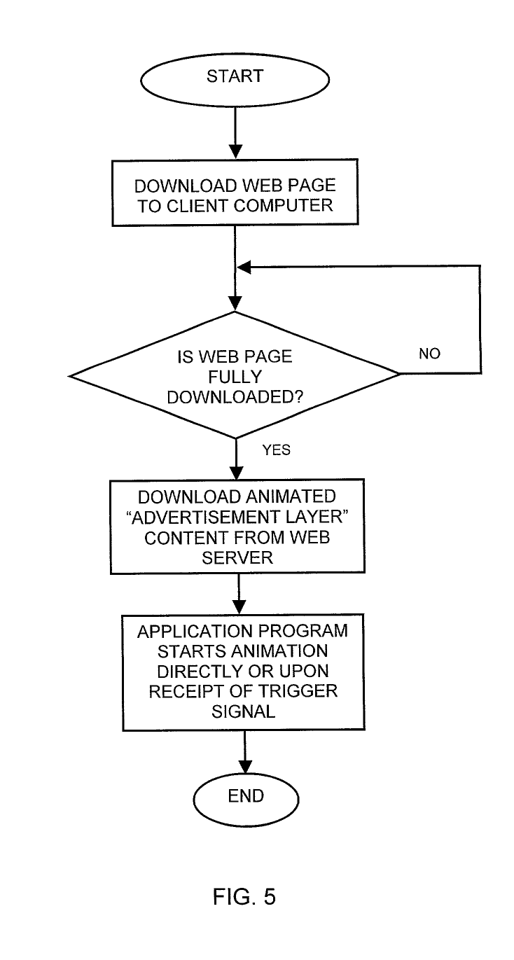

FIGS. 4 and 5 show flow charts of methods carried out by the client computer for presenting an animated advertisement on a web page according to different preferred embodiments. A web page is first downloaded from the web server. A “web page layer” containing an embedded animated advertisement is then superimposed over the web page. The animation is then triggered so that one or more animation objects run across the web page without obscuring or disabling portions of the web page lying outside a boundary of the animation objects at any given instant of time. Typically, the web page layer is itself downloaded from a web server and contains links to animated objects, which themselves are downloaded to the client computer from one or more web servers. In such manner, the animated advertisement content may be added to the web page layer prior to superimposing on to the web page.

In order for the animated advertisement to appear superimposed on the web page, it must first be triggered. This can be done in several ways. Thus, a trigger signal may be sent by the web server to the client for starting the animation a predetermined time interval after downloading to the client computer. Alternatively, the animated advertisement may include an integral trigger signal for running the animated advertisement a predetermined time after being downloaded to the client. According to yet another possibility, a mobile program, such as a Java applet, may be downloaded to the client for creating the trigger signal. Java is a registered trademark of Sun Microsystems Limited.

FIG. 5 shows yet a further embodiment where the animation is a separate application program run independent of the web browser although it may, if desired, be downloaded from the web server, either once and for all or together with each web page. Running the application program compiles a “pseudo-web page layer” and applies the trigger signal for running the animated advertisement. The trigger signal may be independent of any activity performed by the client. Alternatively, the trigger signal may be generated consequent to predetermined activity by the user, such as dragging the mouse and so on. In this embodiment, the animated object may be loaded locally rather than being downloaded from the web server. However, it is conceptually identical to the web page layer described above and for this reason the term “web page layer” is used herein and in the appended claims without regard to the actual source thereof.

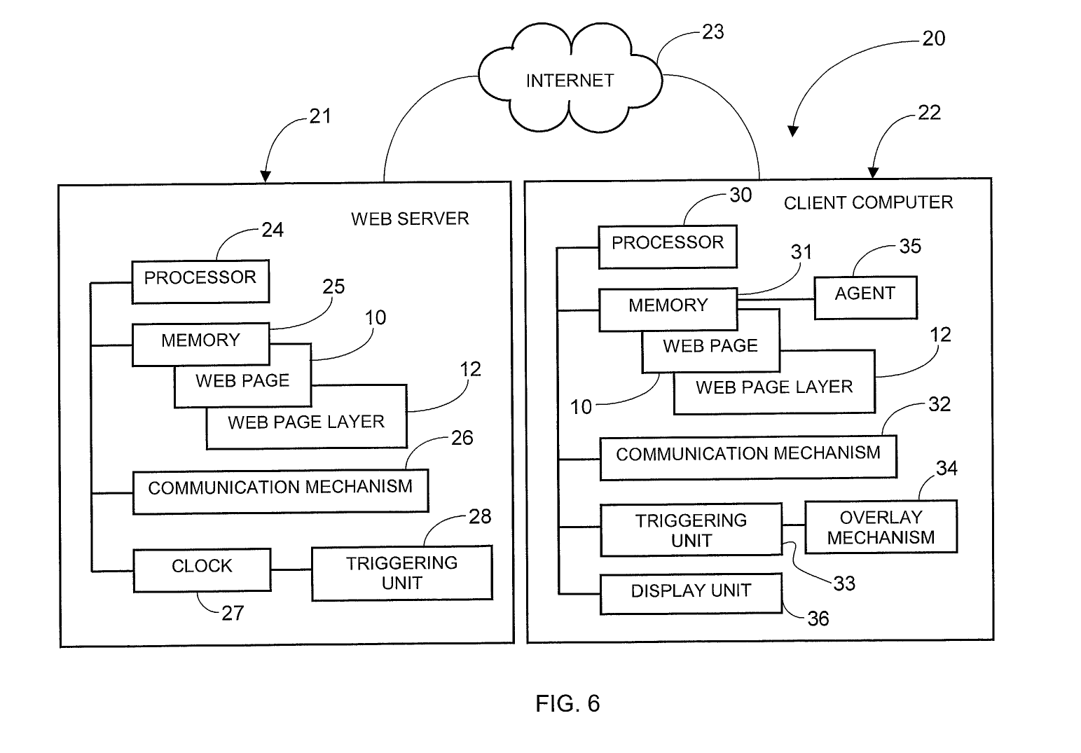

FIG. 6 is a block diagram showing functionally a system designated generally as 20 comprising a web server 21 and a client computer 22 coupled thereto via the Internet 23. The web server 21 comprises a processor 24 and a memory 25 coupled thereto for storing therein the web page 10 and the web page layer 12 containing the animated advertisement. A communication mechanism 26 is coupled to the processor 24 for successively downloading the web page 10 and the web page layer 12 to the client computer 22. A clock 27 is coupled to the processor 24 and a triggering unit 28 is responsively coupled to the clock 27 for sending a trigger signal to the client computer 22 for starting the animated advertisement

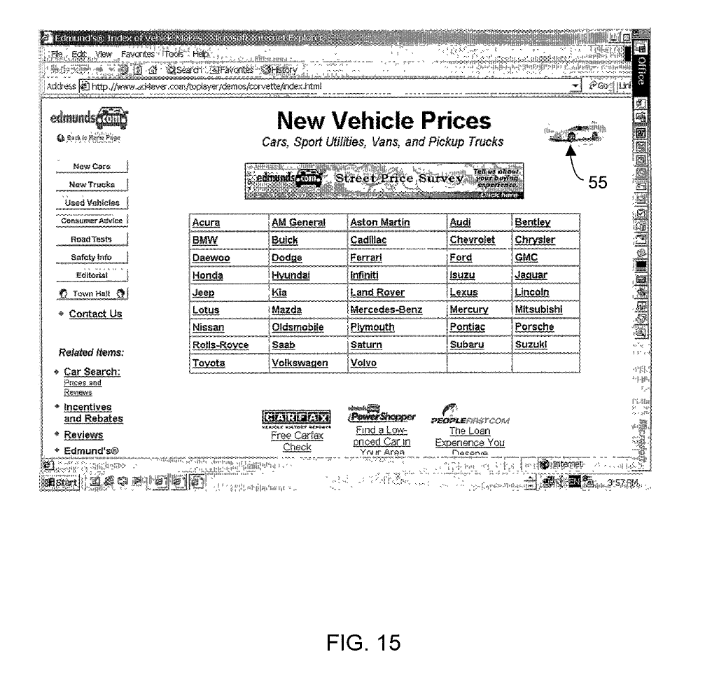

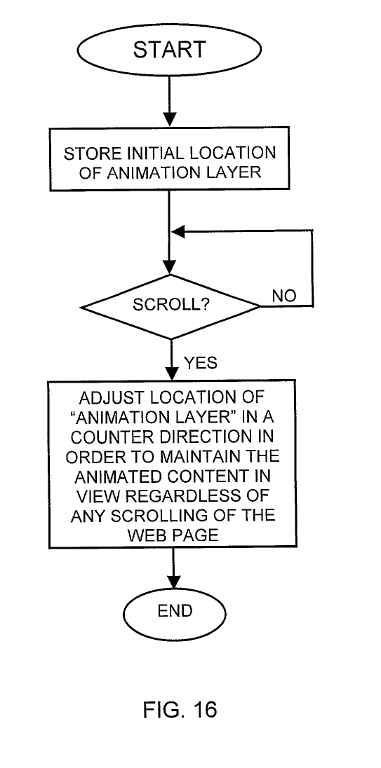

The client computer 22 comprises a processor 30 and a memory 31 coupled thereto and adapted to store therein the web page 10 and the web page layer 12 containing the animated advertisement. A communication mechanism 32 is coupled to the processor 30 for downloading the web page 10 from the web server 21 for storage in the memory 31. A triggering unit 33 coupled to the processor 30 applies a trigger signal for starting the animated advertisement, and an overlay mechanism 34 is coupled to the triggering unit 33 and is responsive to the trigger signal for superimposing the web page layer 12 over the web page 10. Also shown coupled to the memory 31 is an agent 35, that may be downloaded from the web server 21, and acts to maintain the animated advertisement content in view regardless of any scrolling of the web page. By such means, once an animation object is downloaded it may remain substantially stationary relative to a display device 36 on which the web page 10 and the animation layer 12 are displayed. This feature and the manner in which it is achieved are described in greater detail below with reference to FIGS. 15 and 16 of the drawings.

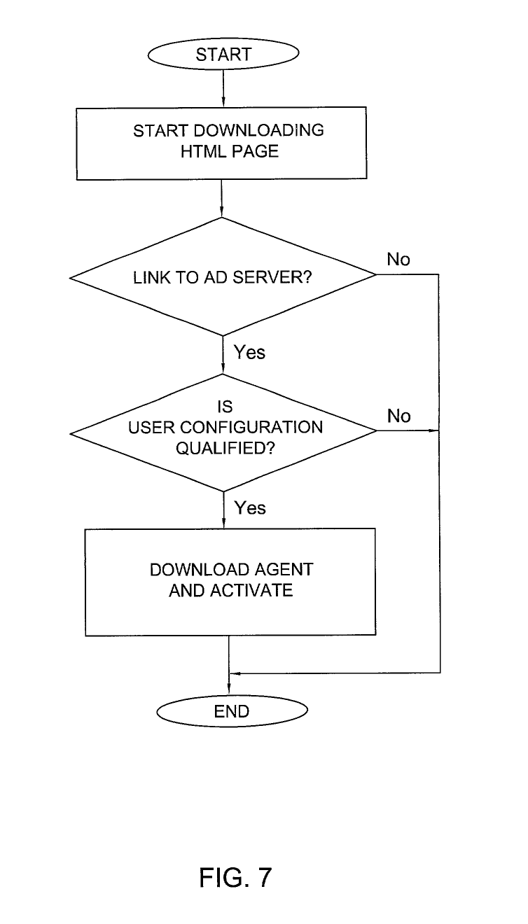

FIGS. 7 to 14 relate to a new method for presenting advertisements in association with a web page, and particularly to such a method that exploits the animation layer described above with reference to FIGS. 1 to 6 of the drawings.

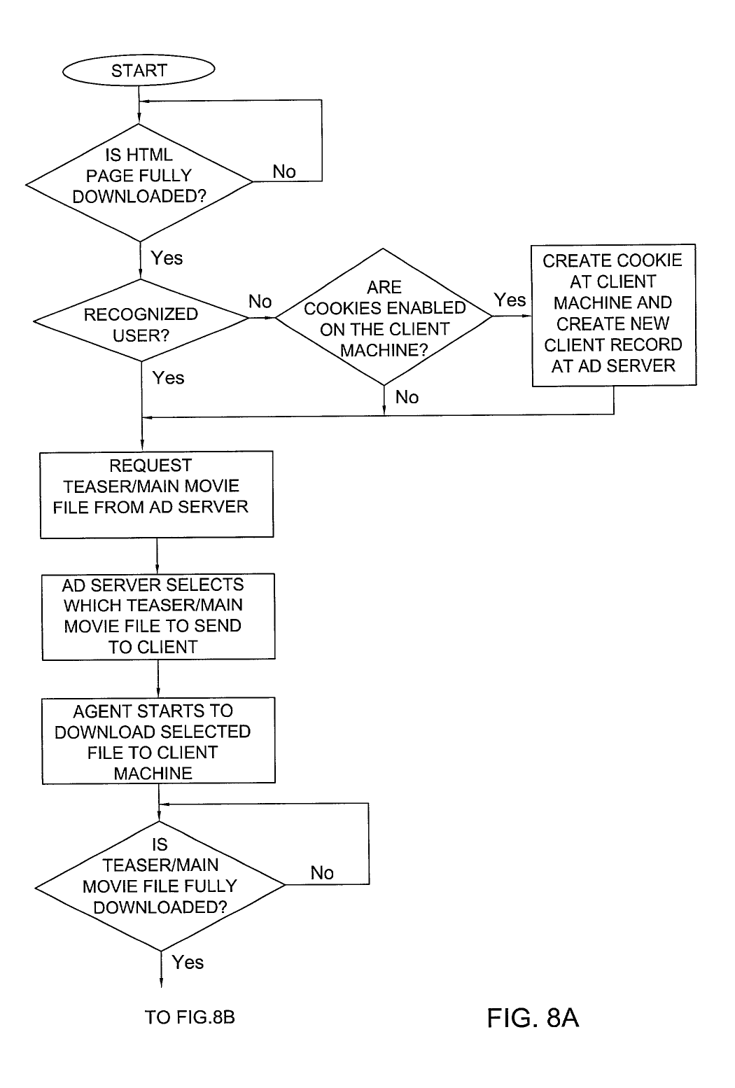

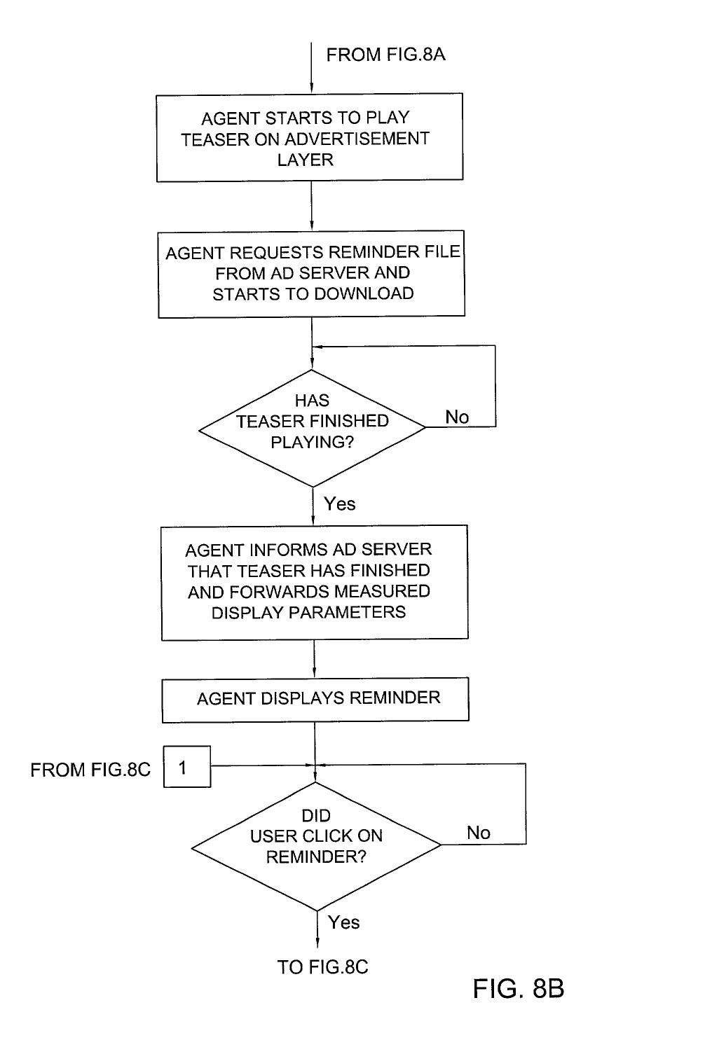

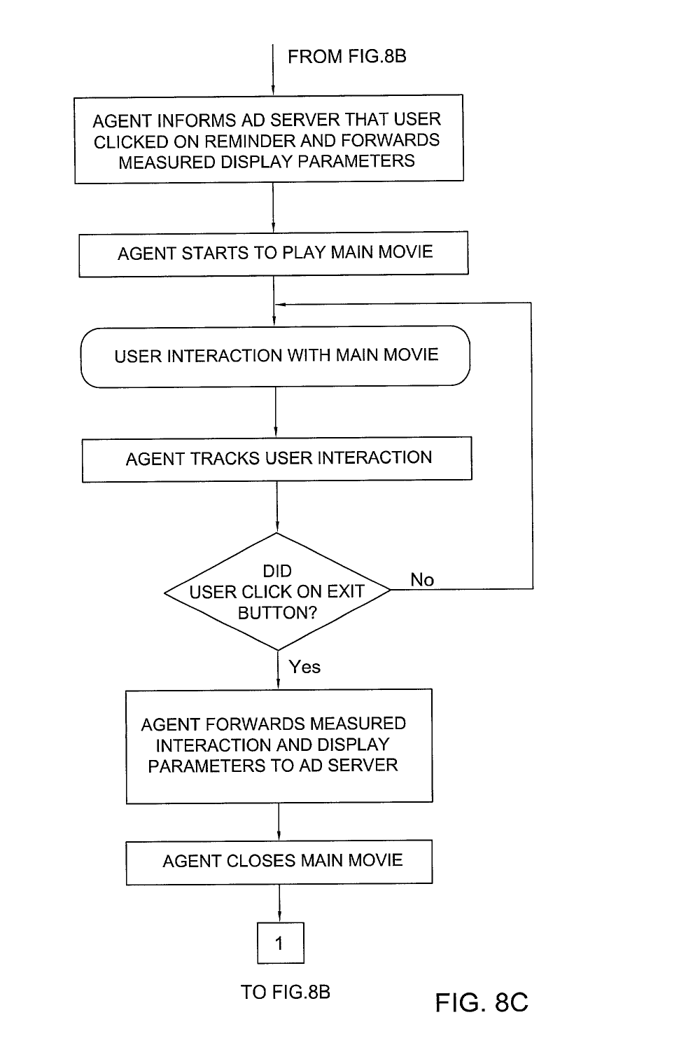

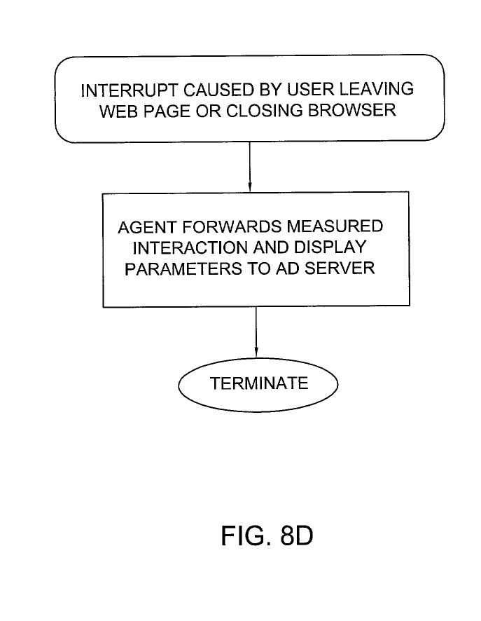

FIG. 7 shows the principal operating steps carried out by a client machine, such as the client computer 22 shown in FIG. 6. Upon downloading an HTML page in the normal manner, the client machine checks whether there is a link to an Ad server, such as the web server 21 in FIG. 6. If not, no further action is required by the client machine so far as the present invention is concerned. However, if a link to the Ad server is found, then the client machine determines whether the user configuration is qualified. If not, then again no further action is taken by the client machine; otherwise, a software agent is downloaded to the client machine from the Ad server. The agent may be a Java applet for interacting with the web browser in the client machine in a manner that will now be described in greater detail with particular reference to FIGS. 8a to 8d of the drawings.

Thus, referring to FIGS. 8a to 8d, the Ad server functions in the conventional manner until the HTML is fully downloaded to the client machine. It then accesses the client machine to locate a cookie loaded at the client machine during a previous session giving access details. If no cookie is found, the user cannot be recognized by the Ad server, and the Ad server checks whether cookies are enabled at the client machine. If so, then a cookie is deposited by the Ad server at the client machine and a new client record is created at the Ad server; if not, then this is not possible.

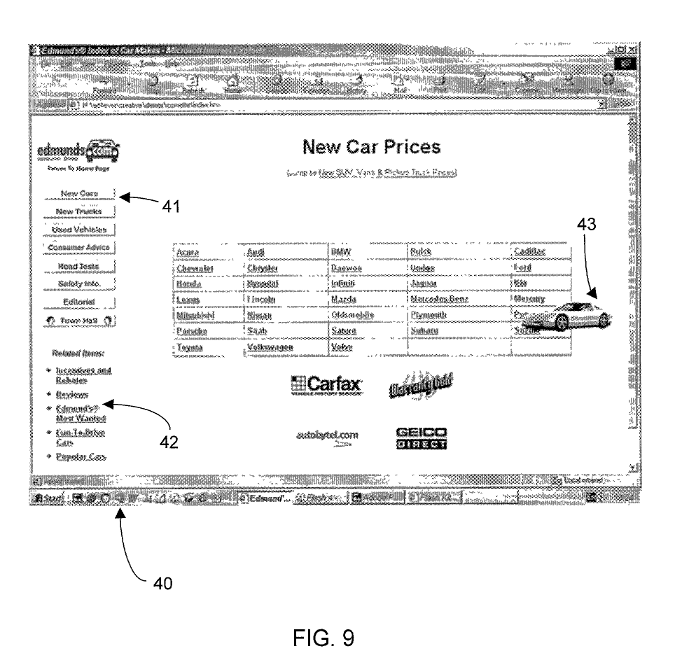

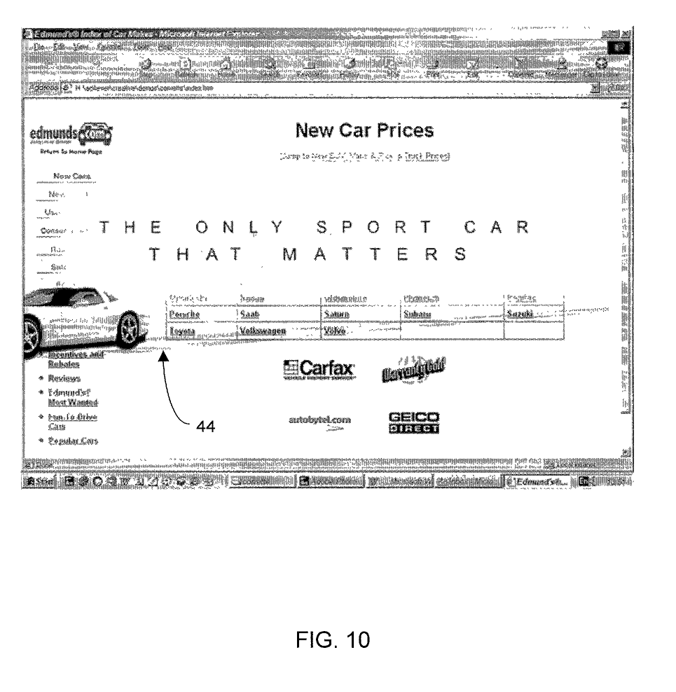

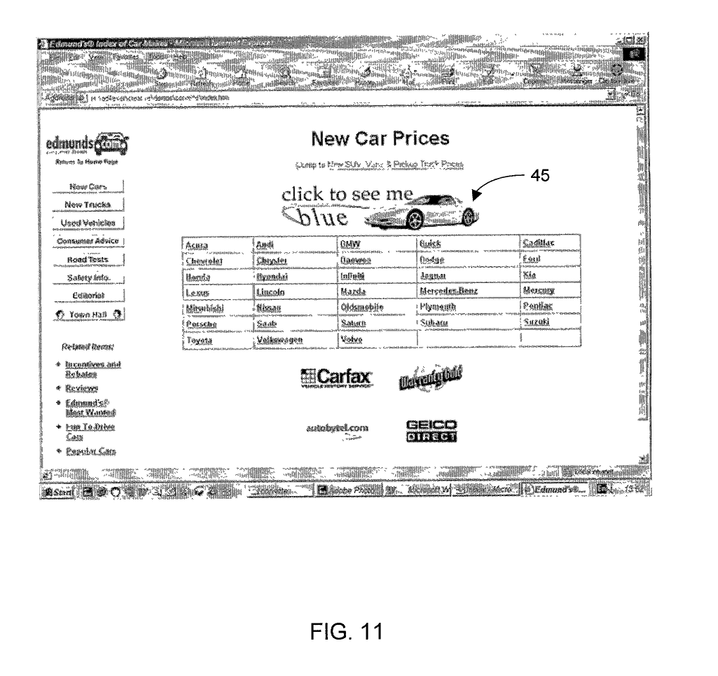

The agent, now resident in the client machine, requests a teaser/main movie file from the Ad server. The meaning of these terms will become apparent from the following description, particularly with reference to FIGS. 9 to 14. Thus, FIG. 9 shows an HTML page 40 displaying a table of automobile manufacturers providing links to competitive prices and having links 41 to other HTML pages also relating to pricing information as well as links 42 to other features. The teaser appears as a car 43 at the edge of the screen and skids across the screen as shown in FIG. 10 leaving skid marks in its wake, until it finally disappears after several seconds, leaving the original HTML page intact as shown in FIG. 11. However, as shown in FIG. 11, there remains a reminder 45 in the form of a car identical to the car 43 displayed in the teaser and beating the legend “click to see me blue”. This serves as a constant reminder of the subject matter associated with the teaser, whilst enticing the user to request more information and to request the main movie associated with the teaser, giving more comprehensive information. At the same time, the original HTML page requested by the user remains completely legible: the reminder being located in advance in a location thereof that barely obscures the data displayed therein.

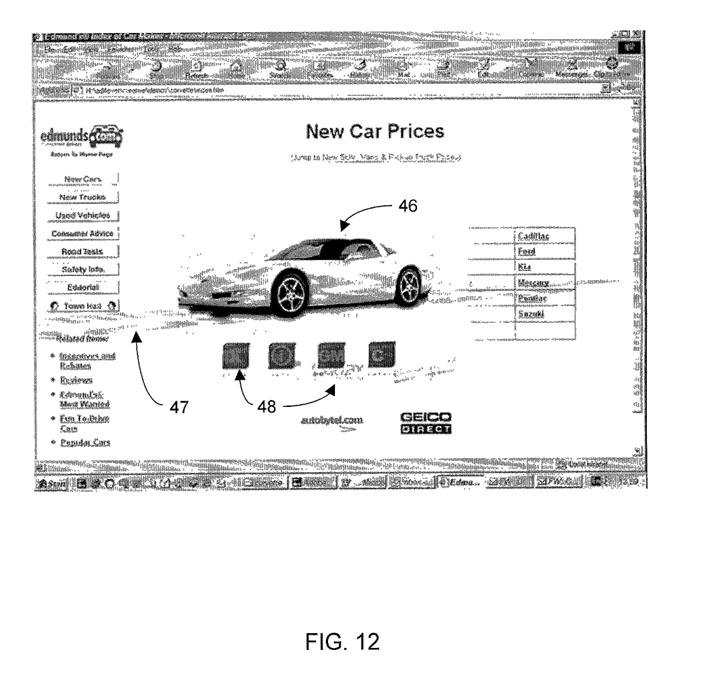

Clicking on the reminder 45 shown in FIG. 11, now causes the main movie to be displayed as shown in FIG. 12 where the car 46 skids across the screen in reverse leaving its skid marks 47 visible and remaining visible together with various command buttons 48 whose operations are indicated via appropriate legends in association with the command buttons 48. For example, one of the command buttons 48 is entitled “Color me!” and causes the car 46, now displayed prominently across a central portion of the screen, to be colored in a different color selected by the user. This is a valuable advertising tool, since it enables the user to view a displayed car in a variety of colors thus enabling her to choose that color of most appeal.

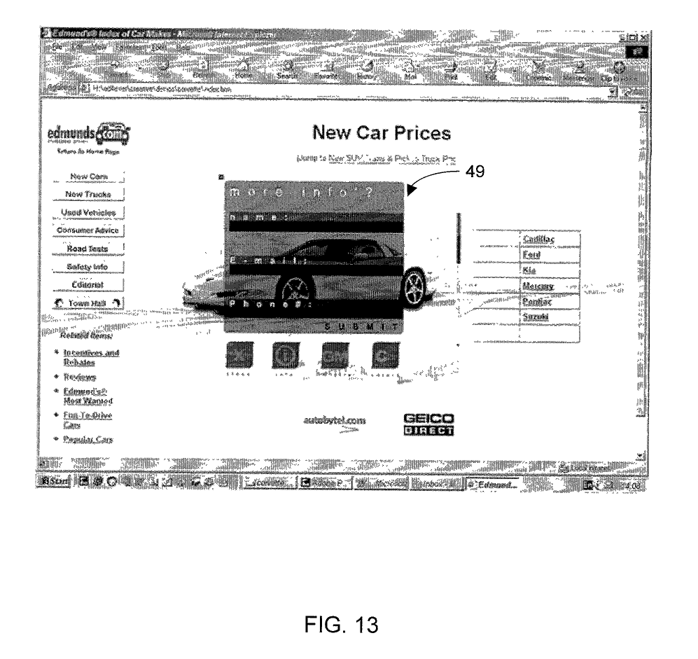

Another command key bears the legend “Info”. On clicking on this button, a table 49 is displayed as shown in FIG. 13 allowing for a user to request more information by entering personal details, such as name, e-mail and telephone number and submitting the completed form by clicking on the “submit” button.

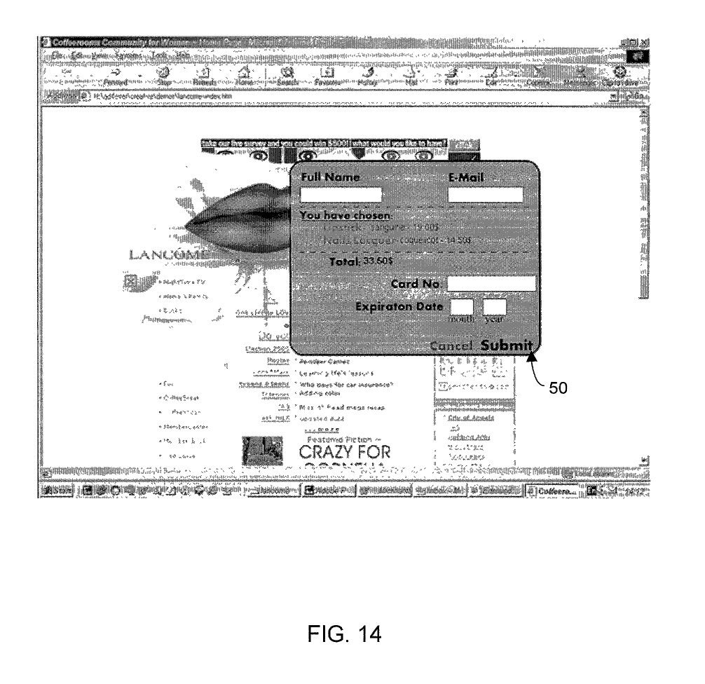

FIG. 14 shows an order form 50 allowing the user to enter his or her name, e-mail address, credit card number and expiry date. “Cancel” and “Submit” buttons allow the order to be cancelled or submitted, thus allowing the user to interact with the advertisement and order a proposed product.

Having explained the relevant terminology, we can revert to FIGS. 8a to 8d and resume the detailed description of the interaction between the software agent loaded at the client machine and the Ad server. As noted, the agent resident in the client machine, requests a teaser/main movie file from the Ad server. The Ad server selects which teaser/main movie file to sent to the client, the selection being based, for example, on a client profile showing client preferences in the event that the cookie was downloaded to the client machine and a record maintained at the Ad server. The agent starts to download the selected teaser/main movie file to the client machine. Once the teaser/main movie file is fully downloaded, the agent starts to play the teaser on the advertisement layer, i.e. render the advertisement layer bearing the teaser using DHTML technology, as explained above with reference to FIGS. 1b and 2b of the drawings. As noted above, the teaser file takes several seconds to play after completion of which the agent informs the Ad server that the teaser has finished and forwards measured display parameters to the Ad server. In particular, the display parameters forwarded to the Ad server relate to the elapsed time during which the advertisement layer bearing the teaser file (and subsequently the movie file) was or were displayed at the client machine. These parameters serve as a mechanism that allows the Ad server to charge its client based on actual display time of the advertisement in much the same manner that television advertisements are charged for.

Thereafter, the agent causes the reminder 45 shown in FIG. 11 to be shown and monitors whether the user clicks on the reminder. When the user clicks on the reminder, the agent informs the Ad server and again forwards measured display parameters to the Ad server. The agent then starts to play the main movie and allows user interaction with the main movie 46 via the command buttons 48 as explained above with reference to FIG. 12. One of the command buttons 48 is an “Exit” button allowing the user to exit. On clicking the “Exit” button, the agent forwards the measured interaction and display parameters to the Ad server. The interaction parameters indicate features of interest to the user and allow the Ad server to fine-tune the user's profile so as to increase the probability that future target advertisements will be of interest to the user and generate a sale, thereby allowing the web site to charge a higher rate from advertisers. After forwarding the measured interaction and display parameters to the Ad server, the agent closes the main movie, and reverts to that part of the process where it displays the reminder and monitors the user clicking the reminder.

FIG. 8d shows a background process that is run by the agent in parallel to the main process shown in FIGS. 8a to 8c and allows a systematic and predictable reaction by the agent in the event of an unorthodox exit by the user at the client machine. Thus, on detecting an interrupt caused by the user leaving the web page or closing the web browser, the agent forwards the measured interaction and display parameters to the Ad server and then terminates.

Referring now to FIG. 15, there is shown a web layer relating to vehicle prices similar to those described above with reference to FIGS. 9 to 14 and upon which an animation sequence is displayed as described above. At the end of the animation sequence, a “reminder” is displayed in the form of a vehicle 55 which remains “floating” at an edge of the screen. The floating reminder may be pseudo 3-dimensional in form and may have associated with it audible and visual effects designed to stimulate the user. For example, the vehicle's headlamps may flash on and off; or the hooter may sound and so on. In a different scenario relating, for example, to mobile telephones, a pseudo 3-dimensional telephone may be shown as a reminder and may intermittently vocalize “hello” or another greeting to attract the user's attention.

FIG. 16 is a flow diagram showing the principal operating steps associated with the software agent 35 shown in FIG. 6 for maintaining the animated advertisement content in view regardless of any scrolling of the web page. Thus, on first downloading the animation layer corresponding to the “reminder” object, the location of the animation layer is recorded. The agent 35 is responsive to either vertical or horizontal scrolling, or both, to shift the animation layer in a counter direction so as to compensate for the scrolling.

It will be understood that other modifications than those specifically described will be apparent to those skilled in the art. Thus, for example, whilst in the preferred embodiment, the animation is created using a vector graphics program, the invention equally well contemplates the use of video clips and other graphics formats.

It will also be understood that the web server and the client computer according to the invention may be suitably programmed computers. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters used to designate claim steps are provided for convenience only and do not imply any particular order of performing the steps.

1. A method for presenting an animated advertisement on a web page, comprising the following steps, all carried out by a web server:
(a) obtaining a web page layer adapted to contain an animated advertisement content having at least one object adapted to run across a web page downloaded to a client computer connected to the web server without obscuring or disabling portions of the web page lying outside a boundary of said objects at any given instant of time,
(b) uploading said web page layer to the client computer for displaying the animated advertisement content in association with the web page, and
(c) uploading to the client computer an agent for maintaining the animated advertisement content in view regardless of any scrolling of the web page.

2. The method according to claim 1, wherein the web page is downloaded to the client computer by said web server.

3. The method according to claim 1, wherein the web page is downloaded to the client computer by a different web server.

4. The method according to claim 1, further including the step of sending a trigger signal to the client computer for starting the animation.

5. The method according to claim 1, wherein the animated advertisement is a video clip.

6. The method according to claim 1, wherein the animated advertisement is a vector animation file.

7. The method according to claim 6, wherein the vector animation file is a Flashy (SWF) file.

8. The method according to claim 1, wherein the trigger signal is independent of any autonomous activity performed by a user of the client computer.

9. The method according to claim 1, further including the step of down-loading to the client a mobile program for creating the trigger signal.

10. The method according to claim 1, wherein the animated advertisement includes an integral trigger signal for running the animated advertisement.

11. The method according to claim 1, wherein step (b) is performed after the web page finished downloading to the client computer.

12. The method according to claim 1, wherein at least part of the at least one object is translucent.

13. The method according to claim 1, wherein the at least one object has a pseudo 3-dimensional form.

14. The method according to claim 1, further including associating sound effects with the at least one object.

15. A web server for presenting an animated advertisement on a web page, the web server comprising:
a processor,
a memory coupled to the processor and storing therein a web page layer adapted to contain an animated advertisement content containing at least one object adapted to run across the web page without obscuring or disabling portions of the web page lying outside a boundary of said objects at any given instant of time, and
a communication mechanism coupled to the processor for successively uploading the web page and the web page layer to a client computer connected to the web server and being adapted to upload to the client computer an agent for maintaining the animated advertisement content in view regardless of any scrolling of the web page.

16. The web server according to claim 15, wherein:
the web page is stored in the memory, and
the communication mechanism successively downloads the web page and the web page layer to the client computer.

17. The web server according to claim 15, wherein the processor is responsive to a clock for sending a trigger signal to the client for starting the animation.

18. The web server according to claim 15, wherein the animated advertisement is a video clip.

19. The web server according to any claim 15, wherein the animated advertisement is a vector animation file.

20. The web server according to claim 15, wherein the at least one object has a pseudo 3-dimensional form.

21. The web server according to claim 15, wherein the communication mechanism is responsive to the processor for downloading to the client a mobile program for creating the trigger signal.

22. The web server according to claim 15, wherein the animated advertisement includes an integral trigger signal for running the animated advertisement.

23. The web server according to claim 15, wherein the communication mechanism is responsive to the processor for downloading the animated advertisement content after the web page finished downloading to the client computer.

24. The web server according to claim 15, wherein at least part of the at least one object is translucent.

25. A program storage device readable by machine, tangibly embodying a program of instructions executable by the machine to perform method steps for presenting an animated advertisement on a web page, comprising the following steps:
(a) obtaining a web page layer adapted to contain an animated advertisement content having at least one object adapted to run across a web page downloaded to a client computer connected to the web server without obscuring or disabling portions of the web page lying outside a boundary of said objects at any given instant of time,
(b) uploading said web page layer to the client computer for displaying the animated advertisement content in association with the web page, and
(c) uploading to the client computer an agent for maintaining the animated advertisement content in view regardless of any scrolling of the web page.

26. A computer program product comprising a computer useable medium having computer readable program code embodied therein for presenting an animated advertisement on a web page, the computer program product comprising:
computer readable program code for causing the computer to obtain a web page layer adapted to contain an animated advertisement content having at least one object adapted to run across a web page downloaded to a client computer connected to the web server without obscuring or disabling portions of the web page lying outside a boundary of said objects at any given instant of time,
computer readable program code for causing the computer to upload said web page layer to the client computer for displaying the animated advertisement content in association with the web page, and
computer readable program code for causing the computer to upload to the client computer an agent for maintaining the animated advertisement content in view regardless of any scrolling of the web page.

27. A method for presenting an animated advertisement on a web page, comprising the following steps all carried out by a client computer connected to a web server:
(a) downloading a web page from the web server,
(b) superimposing over said web page a web page layer containing the animated advertisement having at least one object adapted to run across the web page without obscuring or disabling portions of the web page lying outside a boundary of said objects at any given instant of time and to remain in view regardless of any scrolling of the web page, and
(c) applying a trigger signal for starting the animated advertisement.

28. The method according to claim 27, wherein steps (b) and (c) include running an application program for compiling the web page layer, applying the trigger signal and maintaining the animated advertisement in view regardless of any scrolling of the web page.

29. The method according to claim 28, further including downloading the application program from a web server.

30. The method according to claim 28, wherein the application program generates an integral trigger signal for running the animated advertisement.

31. The method according to claim 27, wherein step (b) includes downloading the web page layer from a web server.

32. The method according to claim 31, further including the step of receiving a trigger signal from a web server for starting the animation.

33. The method according to claim 27, wherein the animated advertisement is a audio/video clip.

34. The method according to claim 27, wherein the animated advertisement is a vector animation file.

35. The method according to claim 27, wherein the trigger signal is independent of any autonomous activity performed by a user of the client computer.

36. The method according to claim 31, further including the step of down-loading from the web server a mobile program for creating the trigger signal.

37. The method according to claim 31, wherein the animated advertisement includes an integral trigger signal for running the animated advertisement.

38. The method according to claim 27, wherein at least part of the at least one object is translucent.

39. The method according to claim 27, wherein the at least one object has a pseudo 3-dimensional form.

40. A client machine for presenting an animated advertisement on a web page, the client machine comprising:
a processor,
a memory coupled to the processor and adapted to store therein a web page and a web page layer containing the animated advertisement containing at least one object adapted to run across the web page without obscuring or disabling portions of the web page lying outside a boundary of said objects at any given instant of time,
a communication mechanism coupled to the processor for downloading a web page from a web server to said memory,
a triggering unit coupled to the processor for applying a trigger signal for starting the animated advertisement,
an overlay mechanism coupled to the triggering unit and responsive to the trigger signal for superimposing over said web page a web page layer, and
an agent for maintaining the animated advertisement in view regardless of any scrolling of the web page.

41. The client machine according to claim 40, wherein the overlay mechanism is constituted by an application program for compiling the web page layer or a “pseudo web page layer” and applying the trigger signal.

42. The client machine according to claim 41, wherein the communication mechanism is adapted to download the application program and/or the agent from a web server.

43. The client machine according to claim 41, wherein the application program is adapted to generate an integral trigger signal for running the animated advertisement.

44. The client machine according to claim 40, wherein the communication mechanism is adapted to download the web page layer from a web server.

45. The client machine according to claim 44, wherein the triggering unit receives a trigger signal from the web server for starting the animation.

46. The client machine according to claim 40, wherein the animated advertisement is a video clip.

47. The client machine according to claim 40, wherein the animated advertisement is a vector animation file.

48. The client machine according to claim 40, wherein the triggering unit is independent of any autonomous activity performed by a user of the client machine for generating the trigger signal.

49. The client machine according to claim 44, wherein the communication mechanism is adapted to download from the web server a mobile program for creating the trigger signal.

50. The client machine according to claim 44, wherein the animated advertisement includes an integral trigger signal for running the animated advertisement.

51. The client machine according to claim 40, wherein at least part of the at least one object is translucent.

52. The client machine according to claim 40, wherein the at least one object has a pseudo 3-dimensional form.

53. A program storage device readable by machine, tangibly embodying a program of instructions executable by the machine to perform method steps for presenting an animated advertisement on a web page, comprising the following steps all carried out by a client computer connected to a web server:
(a) downloading a web page from the web server,
(b) superimposing over said web page a web page layer containing the animated advertisement having at least one object adapted to run across the web page without obscuring or disabling portions of the web page lying outside a boundary of said objects at any given instant of time and to remain in view regardless of any scrolling of the web page, and
(c) applying a trigger signal for starting the animated advertisement.

54. A computer program product comprising a computer useable medium having computer readable program code embodied therein for presenting an animated advertisement on a web page, the computer program product comprising:
computer readable program code for causing the computer to download a web page from the web server,
computer readable program code for causing the computer to superimpose over said web page a web page layer containing the animated advertisement having at least one object adapted to run across the web page without obscuring or disabling portions of the web page lying outside a boundary of said objects at any given instant of time and to remain in view regardless of any scrolling of the web page, and
computer readable program code for causing the computer to apply a trigger signal for starting the animated advertisement.

55. A method for presenting an advertisement on a web page, comprising the following steps all carried out by a client computer connected to a web server:
(a) displaying a brief animated clip relating to a product or service to grab an observer's attention, and
(b) displaying a link to an advertisement stored in association with an advertisement web server associated with said product or service so as to allow the observer to get further information relating to the product or service.

56. The method according to claim 55, further including the steps of:
(c) on terminating display of said further information, re-displaying the link.

57. The method according to claim 55, wherein the brief animated clip serves as a teaser for enticing a user at the client machine to request an advertisement and said link serves as a reminder of the advertisement after termination of the teaser.

58. The method according to claim 55, wherein the animated clip and the advertisement are animated web layers.

59. The method according to claim 55, further including displaying one or more command icons allowing the user to interact with the advertisement.

60. The method according to claim 55, further including maintaining the advertisement in view regardless of any scrolling of the web page.

61. The method according to claim 54, further including associating sound effects with the animated clip.

62. A method for charging for display of an advertisement displayed at a client machine by an ad server on behalf of an advertiser, said method comprising the steps of:
(a) downloading the advertisement to the client machine,
(b) receiving from the client machine an indication of an actual display time during which the advertisement is displayed at the client machine, and
(c) charging the advertiser in accordance with the actual display time.

63. A program storage device readable by machine, tangibly embodying a program of instructions executable by the machine to perform method steps for presenting an advertisement on a web page, comprising the following steps all carried out by a client computer connected to a web server:
(a) displaying a brief animated clip relating to a product or service to grab an observer's attention, and
(b) displaying a link to an advertisement stored in association with an advertisement web server associated with said product or service so as to allow the observer to get further information relating to the product or service.

64. A computer program product comprising a computer useable medium having computer readable program code embodied therein for presenting an advertisement on a web page, the computer program product comprising:
computer readable program code for causing the computer to display a brief animated clip relating to a product or service to grab an observer's attention, and
computer readable program code for causing the computer to display a link to an advertisement stored in association with an advertisement web server associated with said product or service so as to allow the observer to get further information relating to the product or service.

65. A program storage device readable by machine, tangibly embodying a program of instructions executable by the machine to perform method steps for charging for display of an advertisement displayed at a client machine by an ad server on behalf of an advertiser, said method comprising the steps of:
(a) downloading the advertisement to the client machine,
(b) receiving from the client machine an indication of an actual display time during which the advertisement is displayed at the client machine, and
(c) charging the advertiser in accordance with the actual display time.

66. A computer program product comprising a computer useable medium having computer readable program code embodied therein for charging for display of an advertisement displayed at a client machine by an ad server on behalf of an advertiser, said computer program product comprising:
computer readable program code for causing the computer to download the advertisement to the client machine,
computer readable program code for causing the computer to receive from the client machine an indication of an actual display time during which the advertisement is displayed at the client machine, and
computer readable program code for causing the computer to charge the advertiser in accordance with the actual display time.
